(19) United States
(12) Patent Application Publication
(10) Pub. No.: US 2026/0337005 A1
(43) Pub. Date: Oct. 29, 2026

(54) THREADED CONTAINER INSERT KIT FOR CLOSED LOOP DISPENSING SYSTEM

(71) Applicant: Rodney Laible, Omaha, NE (US)

(72) Inventor: Rodney Laible, Omaha, NE (US)

(21) Appl. No.: 19/191,920

(22) Filed: Apr. 28, 2025

(51) Int. Cl. B67D 7/02; B65D 47/06; B65D 47/24

(52) U.S. Cl. CPC B67D 7/0294; B65D 47/06; B65D 47/241; B67D 7/0277

(57) ABSTRACT

A kit for use in dispensing fluid from a container via a cap adapter of closed-loop dispensing system includes a threaded insert configured to be coupled to the container, and a thread reducer configured to be coupled between the threaded insert and the cap adapter. The threaded insert includes an insert housing coupled to a neck of the container, a valve assembly, and a dip tube connected to the valve assembly. The thread reducer includes a lower reducer wall configured to be coupled to an open upper end of the insert housing, an upper reducer wall configured to be coupled to the cap adapter, and a fluid flow coupler configured to open the valve assembly to permit fluid flow from the container through the valve assembly and fluid flow coupler, to the cap adapter, when the thread reducer is coupled to the insert housing of the threaded insert.

### FIELD

This disclosure relates to closed loop dispensing systems, and more particularly to dispensing systems for dispensing fluids, including chemicals, which are typically drawn from a container, such as a bottle with an externally threaded neck. This disclosure further relates to threaded container inserts, and threaded container insert kits, for use with closed loop dispensing systems.

### BACKGROUND

Existing container inserts used to dispense fluids from various containers in a closed system, such as are used to dispense harsh chemicals and cleaning agents from plastic bottles or the like, are often inserted into the neck of the container or bottle, and initially held in place at least partially by an interference fit or press fit between an outer cylindrical surface of the insert's housing and an inner edge or surface of the container's neck portion. Such container inserts typically have an outward facing lip that acts as a physical stop and rests on the top surface of the bottle's neck to prevent the container insert from fully falling into, or being pressed into, an interior of the bottle. A cap adapter, or dispensing cap, is then affixed onto or over the exterior of the container neck (e.g. by a threaded connection between the two), sandwiching the lip of the insert between the top of the bottle's neck and a downwardly facing interior upper surface of the cap adapter, forming a liquid tight seal between each of the neck of the container and the cap adapter. Once the cap adapter, or dispensing cap, is affixed to the container over the container insert, fluid can be withdrawn from an interior of the container through the container insert and the connected cap adapter, via a closed loop negative pressure dispensing system or pump connected to the cap adapter.

This arrangement requires both the outer diameter of the insert's housing and the inner diameter of the container's neck portion to be closely controlled to ensure that the they make contact with each other when the container insert is mated to the neck of the container, and to ensure the lip on the container insert stops the insert at the top edge of the neck of the container. However, in the field of fluid containers, particularly plastic fluid containers, not all container dimensions are closely controlled by their manufacturers, who may then supply such containers to a different company that manufactures the actual fluids/chemicals that will ultimately fill such containers. And yet another third unrelated company will often be the one supplying the fluid dispensing container insert and/or dispensing system to be used to dispense the fluid therefrom in a closed system. In fact, with respect to the neck of such containers, often only the outer diameter dimension of the externally threaded neck of the container is closely controlled by the container manufacturer to have a target value that falls within specific tight tolerances. The reason for this is to ensure that a female internally threaded closure cap, or shipping cap, having inward facing threads, will properly mate and seal with a set of outer threads protruding outward from the outer surface of the neck of the container to ensure the cap stays on the container's neck, and forms a seal with the top surface of the neck of the container. However, the nominal inner diameter dimension of the container's neck typically has significantly larger production tolerances, meaning that for any large production run of bottles for a given bottle design, the actual inner diameter of the neck, from one injection molded plastic bottle to the next, can vary widely from the nominal design diameter and have very large tolerances. For any given bottle design, when plastic bottles are actually produced, if the inner diameter of the neck is too large, the container insert may be loose in the neck of the container and consequently not have the desired interference or press fit with the inner surface or edge of the container's neck. Thus, no liquid tight seal is formed between the container insert and the neck of the container in which it is installed. In extreme situations the inner diameter of the neck may be larger than the outer diameter of the lip on the container insert, so that the lip doesn't even sit on the top edge of the neck of the container as intended, and instead passes fully through the large neck inner diameter to the point that the entire container insert falls into the interior of the bottle. Or if the container's inner neck diameter is too small, it may not be possible to get the container insert to even partially enter the neck of the container, meaning that specific produced bottle can't even be used with the container insert. Accordingly, there is a need for a container insert that can be inserted into the neck of the bottle and secured thereto, which does not need to account for large manufacturing tolerances and variations in the inner diameter of the neck of the container to which it will be secured.

Another issue with existing large commercial chemical dispensing systems is that many of the chemical manufacturers often only sell such chemicals in large volume containers with a container insert for dispensing chemicals pre-installed installed therein. In such situations, a tamperproof fitting is often installed on the container insert that prevents removal of the container insert from the container neck without damaging or destroying the insert, and therefor prevents reuse of the container insert. In that scenario, the customer already has one or more reusable cap adapters connected to their dispensing system that continually get reused with each new container of chemicals. Accordingly, when a container of chemicals is emptied, the customer disconnects the cap adapter from the neck of the empty container and discards or recycles the empty container and the container insert affixed therein. A new container of chemicals with a preinstalled container insert is thereafter purchased, and connected to the dispensing system via the customer's existing cap adapter. That arrangement may be acceptable for large scale customers, such as hospitals, shopping centers, schools, etc. that use large quantities of such chemicals regularly, and have the space to store such large volume containers of chemicals. However, many small businesses or stores have neither the need for, nor the space to store large containers of chemicals, opting instead to simply purchase smaller 1-gallon containers, or the like, of chemicals, such as cleaning supplies, from a big box retail store, such as Home Depot, Loews, or Menards. Such off-the-shelf 1-gallon containers for the consumer market typically have only a screw-on closure cap, but no container insert installed therein that can be connected to a customer's prior installed dispensing system. And the prior existing cap adapters are all largely designed to accommodate much larger threaded container necks for larger containers, rather than that of a typical retail bottle (i.e. 1-gallon or similar consumer sizes) of chemicals. Thus, the threading and inner diameter of the cap adapter is often not even the correct size to accommodate such off-the-shelf consumer chemical bottles. Accordingly, there is also a need for a container insert (and/or reusable container insert), or a container insert kit, that can be inserted by the consumer into an off-the-shelf retail sized container of chemicals (e.g. 1-gallon sized, etc.), and connected to a prior existing cap adapter of a closed loop dispensing system, when the neck of the container has a different size or threading than that which can accommodate the consumer's pre-existing dispenser cap of their dispensing system.

### SUMMARY

An embodiment of a kit for use in dispensing a fluid from a container via a cap adapter of a negative pressure closed-loop dispensing system includes at least a threaded insert and a thread reducer. In one embodiment, the threaded insert can include an insert housing having an internally threaded collar configured to be coupled to an externally threaded neck of the container. The threaded insert can also include an internally threaded open upper end, a valve assembly disposed in the insert housing and having a valve stem that is moveable between an open position and a closed position, and a dip tube in fluid communication with the valve assembly and configured to be introduced into a volume of fluid held within the container. The kit also includes a thread reducer having a cylindrical externally threaded lower reducer wall configured to be coupled to the internally threaded open upper end of the insert housing of the threaded insert. The thread reducer further includes a cylindrical externally threaded upper reducer wall configured to be coupled to internal threads of the cap adapter, and a cylindrical fluid flow coupler configured to be coupled to an upper end of the valve stem and slidingly drive the valve stem from the closed position to the open position to permit fluid flow from the container through the valve assembly and fluid flow coupler, and to the cap adapter, when the thread reducer is coupled to the insert housing of the threaded insert.

In some embodiments, the insert housing may further include a ring-shaped upper wall having an outer radial edge and an inner radial edge, wherein the collar of the insert housing may be a cylindrical outer first sidewall extending downward from the outer radial edge of the ring-shaped upper wall. The internally threaded open upper end of the insert housing may include an internally threaded cylindrical inner second sidewall, disposed radially inward of the first sidewall, and extending downward from the inner radial edge of the ring-shaped upper wall, to define a female open upper end of the insert housing. The insert housing further may include a cylindrical third sidewall disposed below the second sidewall and defining an open lower end of the insert housing. The insert housing may further include a horizontally disposed ring-shaped lower wall protruding inward from an inner surface of the third sidewall, and a cylindrical hollow receiver extending upward from an inner edge of the lower wall. The horizontally disposed ring-shaped lower wall may include a plurality of vent holes defined vertically therethrough. The valve stem may be disposed within the cylindrical hollow receiver in the open upper end of the insert housing. The valve assembly further may include a spring that biases the valve stem to a closed position.

The lower reducer wall of the thread reducer may have a smaller outer diameter than the upper reducer wall. The thread reducer further may include a horizontal ring-shaped wall disposed between, and separating, the lower reducer wall from the upper reducer wall. The horizontal ring shaped wall of the thread reducer may include at least one vertically arranged vent hole defined therethrough. The cylindrical fluid flow coupler of the thread reducer may include an upper coupler body disposed above the horizontal ring shaped wall and coaxially disposed within the upper reducer wall, and a lower coupler body disposed below the horizontal ring shaped wall and coaxially disposed within the lower reducer wall and coaxially aligned with the upper coupler body. The coaxially aligned upper and lower bodies may define a coupler fluid flow path therethrough. The lower coupler body of the thread reducer may include a first socket defined in a lower open end thereof that is configured to mate and form a fluid tight seal with an upper end of the valve stem when the thread reducer is mated to the threaded insert. The first socket may define a shoulder configured to act as a physical stop against which a top surface of the valve stem is configured to abut when the thread reducer is mated to the threaded insert. The upper coupler body is configured to mate and form a fluid tight seal with a coupler receiver of the cap adapter, when the thread reducer is coupled to the cap adapter. The thread reducer may further include a horizontal radial flange extending radially outward from an outer surface of one the upper or lower reducer walls, the radial flange having an upper face configured to act as a physical stop against which a lower edge face of the cap adapter will abut when the thread reducer is fully coupled to the cap adapter.

### BRIEF DESCRIPTION OF DRAWINGS

The present invention is described in detail below with reference to the attached drawing figures, wherein:

FIG. 1 is a partial perspective view of a container insert dispensing assembly of the present disclosure in which the threaded insert is installed onto the throat of a container, with the thread reducer ready to be mated to the cap adapter, and unmated to the threaded insert;

FIG. 2 is a perspective view of a container insert dispensing assembly of the present disclosure in which the thread reducer is mated to the cap adapter, but unmated to the threaded insert;

FIG. 3 is a partial exploded perspective view of a container insert dispensing assembly of the present disclosure in which components of the threaded insert are shown in exploded view, and the threaded insert, thread reducer, and cap adapter are shown exploded from each other;

FIG. 4 is a cross section view of a first embodiment of a fully assembled container insert dispensing assembly of the present disclosure, in which the valve stem is shown in an open position, and the disc member is secured to the insert housing by a threaded connection;

FIG. 5 is a cross section view of a second embodiment of a fully assembled container insert dispensing assembly of the present disclosure, in which the valve stem is shown in an open position, and the disc member is secured to the insert housing by a snap fit connection;

FIG. 6 is a cross section view of the first embodiment of the container insert dispensing assembly as shown in FIG. 4, but in which the combined thread reducer and cap adapter have been uninstalled or unmated from the threaded insert, and the valve stem has returned to a closed position under the biasing force of the valve spring.

### DETAILED DESCRIPTION

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments may be readily combined without departing from the scope or spirit of the present disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

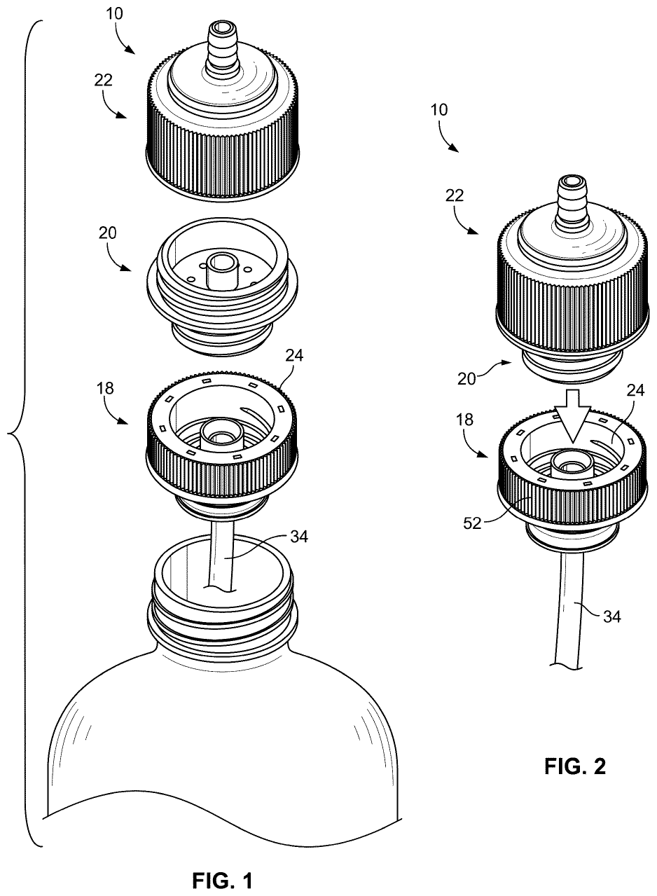

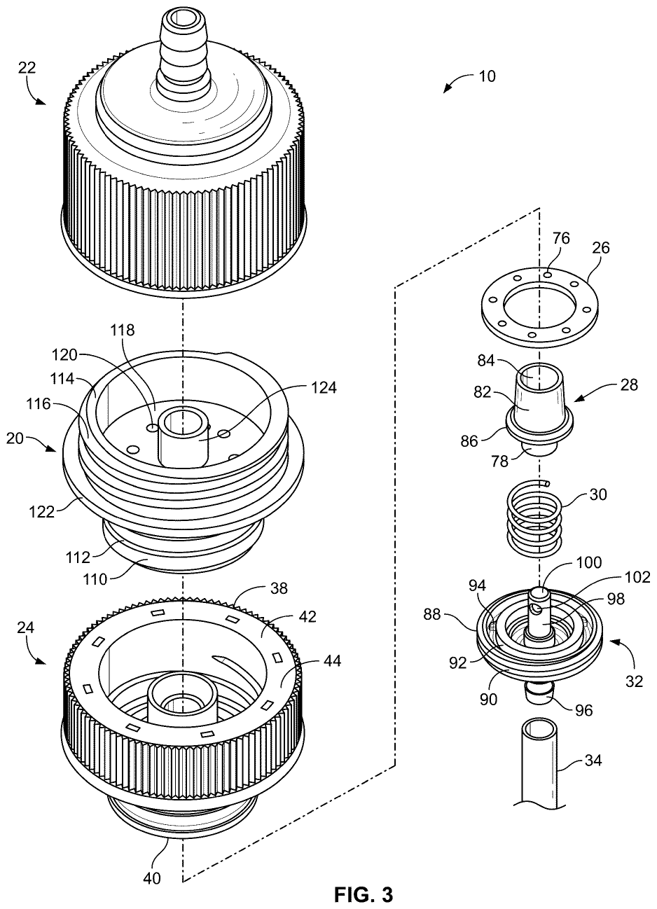

Referring to FIGS. 1 and 2, an embodiment of a container insert dispensing assembly 10 (hereinafter “container insert”), for use in dispensing fluids such as liquid chemicals from a container in a closed loop dispensing system, is shown. The container insert 10 is configured to be inserted into the neck 12, throat, or outlet opening of a container 14 that contains fluids therein to be dispensed therefrom. One example of such a container is a bottle containing a liquid chemical cleaner, or the like, which is to be dispensed from the bottle via a connected negative pressure liquid pump or dispenser. Such pumps and dispensers can be manual pumps, or electric pumps. The neck 12 of the container 14 is cylindrical and includes a plurality of external threads 16 directed radially outward from the neck 12 of the container 14. The container insert 10 is inserted into the neck 12 of the container 14 and secured thereto by screwing the container insert 10 to the threaded neck 12.

The container insert 10 includes a threaded insert 18, a thread reducer 20 secured to an upper internally threaded end of the threaded insert 18, and a cap adapter 22 secured to an upper externally threaded end of the thread reducer 20.

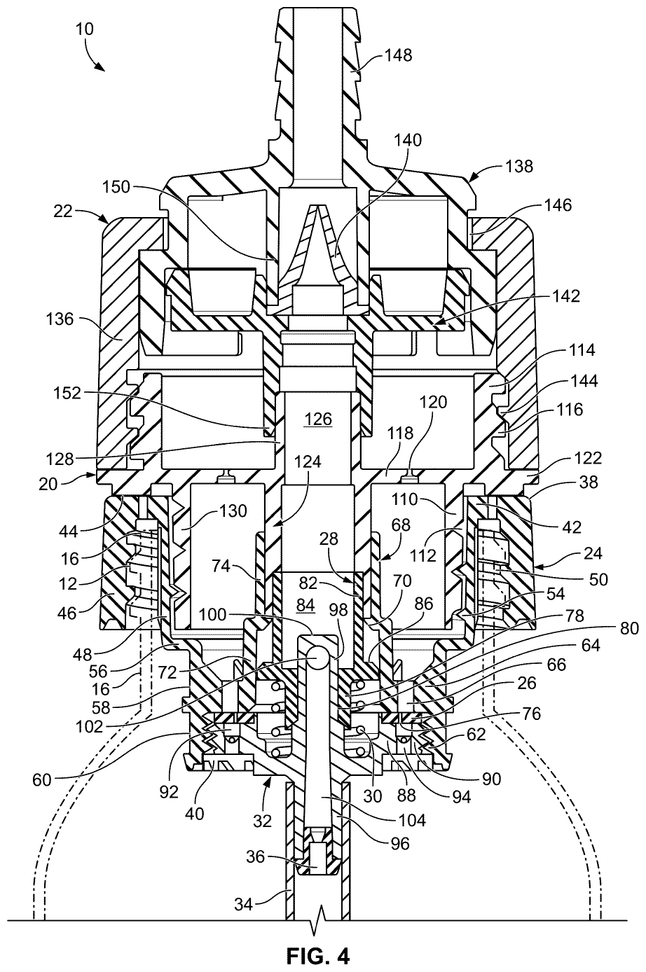

Referring to FIG. 3, one embodiment of the threaded insert 18 may include each of an insert housing 24, a foam liner 26, a valve stem 28, a valve spring 30, a disc member 32, and a dip tube 34. Optionally, the threaded insert 18 may also include a metering tip 36 (shown in FIG. 4).

Referring further to FIGS. 3 and 4, in one embodiment, the insert housing 24 includes an open upper end 38 and an open lower end 40. Insert housing 24 includes a horizontal ring-shaped upper wall 42 defining a top surface 44 of the insert housing 24 at the open upper end 38. A first cylindrical sidewall 46 extends downwardly from an outer radial edge of the ring-shaped upper wall 42, and a second cylindrical sidewall 48 extends downward from an inner radial edge of the ring-shaped upper wall 42. An inner cylindrical surface of the first cylindrical sidewall 46 faces radially inward towards a central longitudinal axis of the insert housing, and has first internal threads 50 disposed therein or thereon that also face the central axis. In this manner, the first cylindrical sidewall 46 is an internally threaded and downward extending outer collar of the insert housing 24. These first internal threads 50 on the first sidewall 46 of insert housing 24 are configured to be mated or screwed together with the external facing threads 16 disposed on the neck 12 of the container 14 to which the threaded insert 18 is to be secured or mated. An outer cylindrical surface of the first cylindrical sidewall 46 faces radially outward away from a central axis of the insert housing 24, and may include a surface texture 52, such as a knurled, grooved, or other such textured surface defined thereon, so as to provide a grip surface to aid in the manual screwing together (and/or unscrewing) of the insert housing 24 to (or from) the neck 12 of the container 14.

Referring further to FIGS. 4-6, an inner cylindrical cap adapter surface of the second cylindrical sidewall 48 has second internal threads 54 disposed therein or thereon that face radially inward towards the central axis of the insert housing 24. An outer diameter of the second cylindrical sidewall 48 is significantly smaller than the inner diameter of the neck 12 of a container 14 to which the threaded insert 18 is to be attached, so that the second cylindrical sidewall 48 will never prevent the threaded insert from being mated to or installed in/on the neck 12 of a container 14. At a bottom edge of the second sidewall 48 is a horizontally disposed ring-shaped middle wall 56 extending radially inward therefrom. A third cylindrical sidewall 58 extends downward from an inner edge of the ring shaped middle wall 56. A groove 60 is defined in an outer cylindrical surface of the third cylindrical sidewall 58. This groove 60 is configured to accommodate an optional tamper evident ring (not shown) that can be snapped therein, so as to prevent the threaded insert 18 from being removed from the container 14, or prevent such removal without damaging the tamper evident ring so as to visibly show or indicate that the threaded insert 18 had previously been installed in and thereafter removed from the neck 12 of a container 14. In one embodiment, the third cylindrical sidewall 58 includes an inner cylindrical surface, at a lower end of which is defined a third set of internal threads 62 disposed therein or thereon that also face the central axis. A horizontally disposed ring-shaped lower wall 64 protrudes inward from the inner surface of the third sidewall 58, at a position along the sidewall 58 located above and adjacent to an upper end of the third internal threads 62. The horizontal ring shaped lower wall 64 includes a plurality of vent holes 66, apertures, or perforations defined therethrough that are evenly spaced around the central axis in the lower wall 64. In one embodiment, there are eight vent holes evenly spaced around the central axis in the lower wall 64, however, in alternate embodiments, an alternate number of vent holes with any alternate spacing may be included without departing form the scope of the present disclosure. The number and size (e.g. diameter) of the ventholes can be adjusted as needed to achieve the desired venting effect within the specific container 14 to which the bottle insert 10 is to be inserted and attached. The vent holes 66 permit atmospheric venting air to enter the container 14 therethrough when a negative pressure vacuum is created in the container 14 upon drawing the fluid in the container out via the dispensing system. A cylindrical hollow receiver 68 with cylindrical sidewalls extends upwards from an inner edge of the ring shaped lower wall 64 and includes an inward protruding annular lip 70. The lip 70 divides the hollow receiver 68 into a lower receiver 72 and an upper receiver 74, and acts as a physical stop for the valve stem 28, as will be discussed in further detail below. In one embodiment, the lower receiver 72 has a greater inner diameter than the upper receiver 74. However in alternate embodiments, the lower and upper receivers 72, 74 can have alternate respective diameters without departing from the scope of the present disclosure

In one embodiment, the foam liner 26 is a flat horizontal ring-shaped, or washer-shaped disc. In one embodiment, the foam liner 26 has a plurality of evenly spaced apart vent holes 76 or apertures defined therethrough. However, in alternate embodiments, the foam liner may not include any vent holes defined therein. The choice on whether to utilize a foam liner 26 having vent holes 76 defined therein, or without vent holes, depends on the desired venting effect when the container insert 10 is attached to a container 14. In one embodiment, the foam liner 26 (either with, or without, vent holes) may be positioned in the bottom open end of the insert housing 24, such that a top surface of the foam liner 26 is disposed adjacent to and in contact with a lower surface of the ring shaped lower wall 64 of the insert housing 24.

Referring further to FIGS. 3, 4, and 6, the valve stem 28 is a generally hollow cylindrical body member that includes a cylindrical lower body portion 78 having a cylindrical lower bore 80 coaxially defined therethrough, and a cylindrical upper body portion 82 having a cylindrical upper bore 84 defined therethrough. The lower and upper bores 80, 84 together define a continuous bore or path through the valve stem 28 along a central axis thereof, such that they are connected and otherwise in communication with each other. A diameter of the upper bore 84 is greater than a diameter of the lower bore 80. A horizontal annular flange 86 extends outward from an outer surface of the valve stem 28 at a location between the lower and upper body portions 80, 84, or alternatively, at a bottom end of the upper body portion 82. The valve stem 28 is disposed in hollow receiver 68 of the insert housing 24, such that the upper body portion 82 of the valve stem 28 is disposed substantially within the upper receiver 74 of the insert housing 24, the lower body portion 78 of the valve stem 28 is disposed in the lower receiver 72 of the insert housing 24, and the upper surface of the valve stem's annular flange 86 is abutted against a lower surface of the lip 70 of the hollow receiver. In this manner, lip 70 of the hollow receiver 68 in the threaded insert 18 acts as an inwardly directed physical stop, against which the outwardly directed annular flange 86 can make contact and be seated against, in order to prevent the lower body portion 78 of the valve stem 28 from entering into the upper receiver 74 of the threaded insert.

Referring further to FIGS. 3, 4 and 6, in one embodiment, the disc member 32 has a disc-shaped body 88 that includes external threads 90 defined in an outer circumferential surface of thereof. The external threads 90 of the disc member 32 are configured to be screwed together with, and threadedly secured to, the complementary internal third internal threads 62 disposed in the lower open end of the insert housing 24. In one embodiment, when the disc member 32 is secured in the lower end of the insert housing 24, the foam liner 26 may be sandwiched or secured between an upper surface of the disc-shaped body 88 of the disc member 32 and the bottom surface of the ring-shaped lower wall 64 of the insert housing 24. In alternate embodiments, the foam liner 26 may be omitted depending on the desired venting effect through the threaded insert 18, without departing from the scope of the present disclosure.

Referring further to FIGS. 3-6, the upper surface of the disc-shaped body 88 of the disc member 32 includes an annular or circular groove 92 defined therein that is concentric with the disc-shaped body 88. A plurality of vent holes 94 or apertures are defined in the disc-shaped body 88 at the bottom of the groove 92 that extend downward through the bottom surface of the disc-shaped body 88 as through holes. In one embodiment, the vent holes 94 are disposed evenly about a central axis of the disc member 32. Extending downward from a cylindrical center of the bottom face of the disc-shaped body 88 is a hollow barbed dip tube fitting 96. The barbed fitting 96 is generally cylindrical, and concentric with the disc-shaped body 88, with at least one external tapered cylindrical barb defined on an outer surface thereof that is configured to permit an upper end of a hollow dip tube to be slidably affixed thereto or thereon and held in place by the at least one barb. The dip tube is configured to have its lower end inserted into the fluid container 14 to permit fluid contained therein to be drawn upward from the lower end of the dip tube and into the disc member 32 at the barbed fitting 96. Extending upward from the cylindrical center of the top face of the disc-shaped body 88 is a hollow cylindrical valve body 98. The valve body 98 has a hollow longitudinal center, a closed top end 100, and a pair of opposing sideways-facing lateral openings 102 defined in a cylindrical sidewall of the valve body 98 at an upper end of the hollow center. The hollow centers in each of the barbed fitting 96 and the valve body 98 are centrally aligned along the central axis of the disc-shaped body 88 (i.e. colinear), and are connected with each other so as to form a central fluid flow path 104 through the disc member 32, which fluid flow path 104 exits at the top end thereof through the sideways-facing lateral openings 102. The valve body 98 is slidably engaged with and disposed within the lower bore 80 of the lower body portion 78 of the valve stem 28, so as to be colinear with the valve stem 28.

In one embodiment, a valve spring 30 is disposed between the valve stem 28 and the disc member 32 and is configured to bias the valve stem 28 on the valve body 98 in an upwards direction, away from the disc member 32. In one embodiment, the valve spring 30 is a compression spring, such as a helical compression spring, a wave spring, or the like. In such embodiment, the valve spring 30 has an inner diameter larger than the outer diameter of each of the lower body portion 78 of the valve stem 28 and the valve body 98. The valve spring 30 is disposed such that it fully surrounds and is concentric with both of the lower body portion 78 of the valve stem 28, and the valve body 98 that is slidingly mated within the lower bore of the valve stem 28. In other words, the mated lower body portion and valve body are centrally disposed within the valve spring 30. The valve spring 30 serves to bias the valve stem 28 upwards, to a closed position, until the outward extending annular flange 86 of the valve stem 28 abuts and physically stops on the inward extending lip 70 of the hollow receiver. In this closed position of the valve stem 28, the closed top end 100 of the valve body 98 and the lateral openings 102 in the valve body 98 are fully seated within the lower bore 80 of the hollow receiver, thereby fully covering or closing off the lateral openings 102 of the valve body 98 with an internal face of the lower bore 80, and closing the fluid flow path 104, to prevent any fluid from being able to pass through the lateral openings 102 in the valve body 98. In this closed position, the valve stem 28 prevents any fluid from being drawn from the container 14. In order to draw or dispense fluid from the container 14 to which the threaded insert 18 is attached, the valve stem 28 must be forced or depressed downward against the biasing force of the valve spring 30, to its open position. Forcing the valve stem 28 downward to its open position causes the closed top end 100 and the lateral openings 102 in the valve body 28 to protrude upward into the larger diameter upper bore 84 of the upper body portion 82 of the valve stem 28, which upper bore 84 has a larger internal diameter than that of the lower bore 80 in the lower body portion 78, thereby uncovering, or opening, the lateral openings 102 in the valve body 98. With the lateral openings 102 in the valve body 98 open and uncovered to permit fluid to flow therefrom or therethrough, fluid can now be drawn up from the container 14 through the dip tube and fluid flow path 104 of the disc member 32, and out the upper bore 84 of the valve stem 28 in the threaded insert 18. In one embodiment, the lower bore 80 of the valve stem 28 being slidingly mated onto the valve body 98 of the disc member 32, with the valve spring 30 disposed therebetween, together forms a valve assembly 105.

In an alternate embodiment (not shown) the valve assembly 105 may be similarly constructed with a valve stem slidably disposed on the valve body 98, as disclosed above, but wherein the helical compression spring is replaced by an alternate type of dynamic spring. In such embodiment, the insert housing 24 can be partially overmolded by a layer of a compressive dynamic polymer (e.g. rubber, or a rubber like polymer), and a layer of such polymer can be disposed on the insert housing 24 surrounding a lower half of the valve body 98. In this manner a bottom face of the lower body portion 78 of the valve stem 28 rests on, and is biased upward on the valve body 98 by, the layer of dynamic polymer on the lower half of the valve body 98. When the valve stem is driven downward, the lower body portion 78 of the valve stem 28 compresses the dynamic polymer to permit the closed top end 100 and the lateral openings 102 of the valve body to protrude into the upper bore 84 in the upper body portion 82 of the valve stem 28, thus opening the lateral openings 102 in the valve body 98 to permit fluid to flow therefrom.

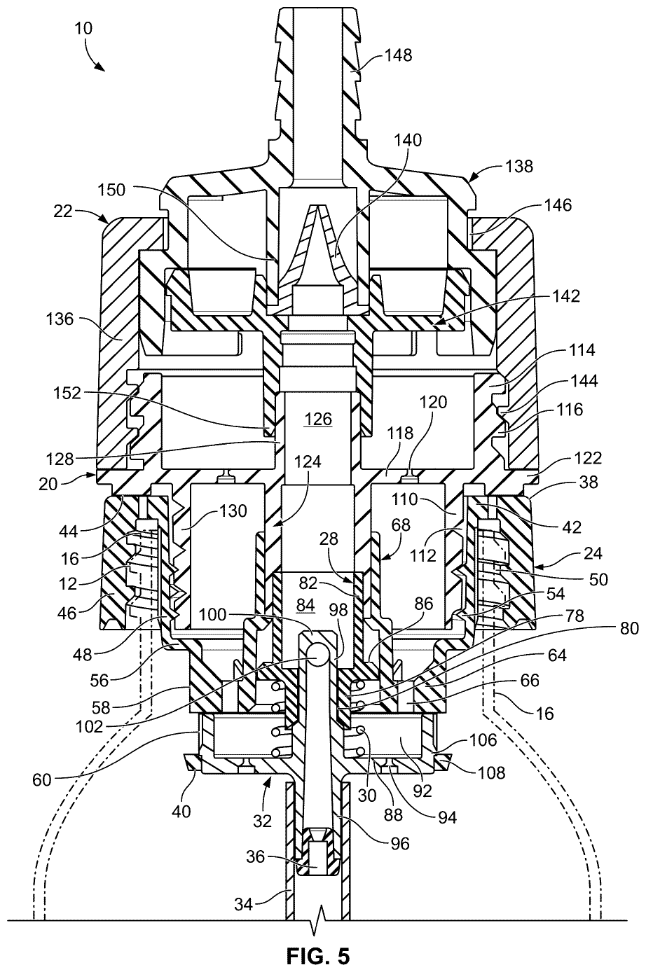

In one embodiment of the present disclosure discussed above, the disc member 32 is secured to the threaded insert 18 by a threaded connection, whereby threads 90 on the disc member 32 are screwed together with, or threadedly secured to, the third internal threads 62 on the third sidewall 58 in the open bottom of the insert housing 24. However, referring to FIG. 5, in alternate embodiments, such threaded connection can be replaced by a snap fit between the threaded insert 18 and the disc member 32. In such an alternate embodiment, the threads on the disc member 32 can be replaced with a single tapered snap ring 106 (or alternatively a plurality of tapered snap lugs spaced around the outer periphery of the disc member), that mate with a one or more complementary snap catch 108 (or snap lip) defined on (or recessed in) an inner face of the third sidewall 58 of the insert housing 24. In still alternate embodiments, the snap ring 106 or snap lugs can be disposed in the third sidewall 58 at the lower open end of the insert housing 24, and the snap catch 108 can be defined in or on the disc member 32 without departing from the scope of the present disclosure. In embodiments in which the disc member 32 is secured to the insert housing 24 by snap fit, a foam liner 26 can be either be sandwiched between the disc member 32 and the insert housing 24, or omitted entirely, depending on the desired venting effect through the threaded insert 18 when fluid is to be drawn from the container 14 to which the threaded insert 18 is attached.

Referring again to FIGS. 4-6, a metering tip 36 may be inserted into the open lower end of the barbed dip tube fitting 96, and an upper end of the dip tube 34 is thereafter secured onto the barbed dip tube fitting 96. In this manner, the metering tip 36 is also disposed or affixed within the upper end of the dip tube 34. Such metering tip 36 is configured to limit or set the flow rate of the fluid to be drawn out of the container 14 through the dip tube and metering tip, and through the threaded insert 18. The fully assembled container insert 10 is configured to be mated to the external threads 16 on the neck of a container 14 that is filled with fluid to be dispensed therefrom.

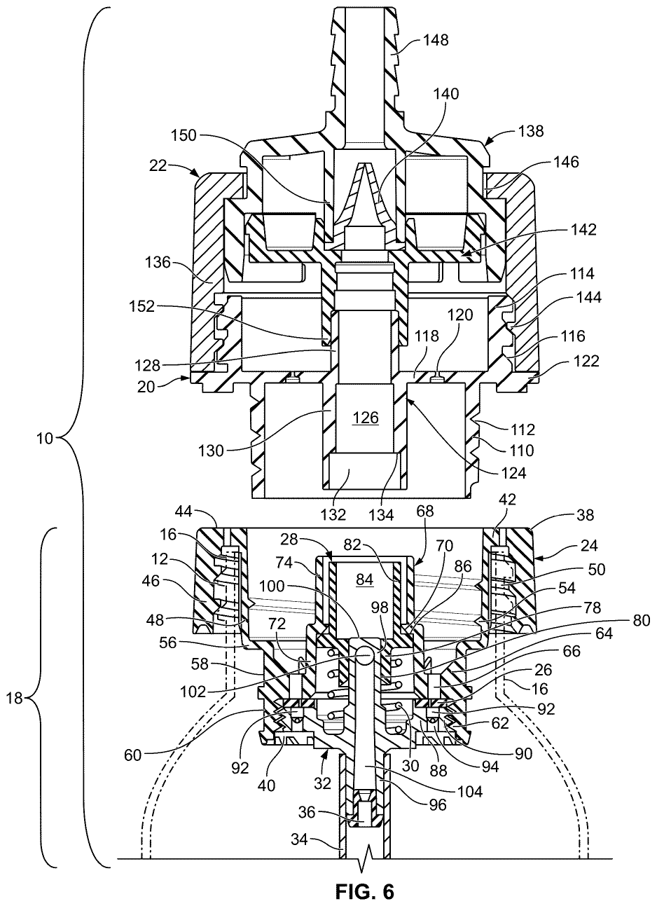

When nothing is affixed to the open upper end 38 of the insert housing 24 of the threaded insert 18, the valve stem 28 is biased to its upper closed position by the valve spring 30 (see FIG. 6), and no fluid can either flow from or be drawn from the container 14 to which the threaded insert 18 is attached. In order to draw fluid from the container 14, an additional structure must be coupled or secured to the open upper end 38 of the insert housing 24, which will enter the upper receiver 74 of the insert housing 24 and depress the valve stem 28 downward so as to move the valve stem 28 from its closed position (as shown in FIG. 6) to its open position (as shown in FIGS. 4-5). For this purpose, a thread reducer 20, affixed or coupled at its top end to a cap adapter 22 in fluid communication with a fluid pump or dispenser, may be utilized.

Referring to FIGS. 3-6, the thread reducer 20 is a male-to-male externally threaded adapter fitting that permits the coupling of an internally threaded female cap adapter 22, to the internally threaded female open upper end 38 of the insert housing 24. The cap adapter 22 has a first inner diameter and/or first internal thread sizing, and the open upper end 38 of the insert housing 24 has a second inner diameter and/or second internal thread sizing that may be different than those of the cap adapter 22. In one embodiment, the first inner diameter of the cap adapter 22 is larger than the second inner diameter of the open upper end 38 of insert housing 24. However, in alternate embodiments, the second inner diameter may be larger than the first inner diameter. Referring to FIG. 6, in one embodiment, the thread reducer 20 includes a cylindrical lower reducer wall 110 having a first threading 112 defined in or on an external surface thereof, and a coaxial cylindrical upper reducer wall 114 having a second threading 116 defined in or on an external surface thereof. In one embodiment, the upper reducer wall 114 has an outer diameter that is complementary to an inner diameter of the cap adapter 22 to which the upper thread reducer wall 114 will be mated by a screw together threaded connection. In one embodiment, the upper reducer wall 114 has an outer diameter that is larger than the outer diameter of the lower reducer wall 110. The lower reducer wall 110 has an outer diameter that is complementary to an inner diameter of the second cylindrical sidewall 48 of the insert housing 24 to which the second cylindrical sidewall 48 will be mated. The lower and upper reducer walls 110, 114 are separated by a horizontally disposed ring-shaped reducer vent wall 118. The reducer vent wall 118 includes a plurality of vent holes 120 or vent apertures extending downward therethrough. In one embodiment, the vent holes 120 are uniformly or evenly spaced apart in the reducer vent wall 118 around a central axis of the thread reducer 20. The thread reducer 20 also includes a ring-shaped outer flange 122 extending outward from an outer surface of the thread reducer 20 that is positioned between the first external threading 112 of the lower reducer wall 110 and the second external threading 116 of the upper reducer wall 114. The flange 122 includes a plurality of protrusions disposed on and extending downward from a lower face of the flange 122 that are configured to brought in contact with, or be seated against, the top surface 44 of the insert housing 24 of the threaded insert 18, when the lower reducer wall 110 of the thread reducer 20 is threadably mated to, or screwed into, the upper end 38 of threaded insert 18. Disposed in the center of the thread reducer 20 is a cylindrical fluid flow coupler 124 defining a coupler flow path 126 through the thread reducer and extending along an axial length of the coupler 124. The fluid flow coupler 124 includes an upper coupler body 128 concentrically aligned with a lower coupler body 130. A first cylindrical socket 132, concentric with the lower coupler body 130, is defined in an interior surface of the lower coupler body 130 and is configured to accept and mate with the upper body portion 82 of the valve stem 28 that is to be inserted upward therein, as will be discussed below. The socket 132 includes a shoulder 134 defined therein that acts as a physical stop against which a top face of the upper body portion 82 of the valve stem 28 is to be seated when fully inserted into the first socket 132. The first socket 132 makes a snug fit with, and forms a liquid tight seal against, an outer surface of the upper body portion 82 of the valve stem 28 when the thread reducer 20 is fully mated to, and/or inserted into, the insert housing 24 of the threaded insert 18. Moreover, when the thread reducer 20 is fully mated to the insert housing 24 of the threaded insert 18, the shoulder 134 of the first socket 132 makes contact with the top face of the valve stem 28 and forces or drives the valve stem 28 slidingly downward along the valve body 98 against the biasing force of the valve spring 30, and into its open position. As discussed above, with the valve stem 28 driven downward to its open position, the closed top end 100 and the lateral openings 102 of the valve body 98 protrude upward into the larger diameter upper bore 84 in the upper body portion 82 of the valve stem 28, thereby uncovering the lateral openings 102 to permit fluid flow upward from the container 14, through each of the dip tube 34, any installed metering tip 36, the fluid flow path 104 defined by the coaxially aligned barbed dip tube fitting 96 and valve body 98 of the disc member 32, the lateral openings 102 in the valve body 98, the valve stem 28, and the coupler 124 of the thread reducer 20.

Referring to FIGS. 3-6, in one embodiment, the cap adapter 22 includes a cylindrical outer collar 136, a cap member 138, a check valve 140, and a receiver body 142. The cylindrical outer collar 136 has internal threads 144 defined in or on a cylindrical inner surface thereof and an open upper end 146. The collar 136 is configured to be threadedly secured to the external threads of the thread reducer 20, by screwing the threads 138 on the collar 136 to the second external threads 116 on the outside of the upper reducer wall 114 of the thread reducer 20. The cap member 138 includes a hollow upper barbed hose fitting 148 configured to be coupled to a draw hose of a negative pressure fluid pump or fluid dispenser, and a hollow central valve housing 150 disposed adjacent and coaxially aligned with a lower end of the upper barbed hose fitting 148, to define a continuous fluid flow path through the valve housing 150 and the upper barbed hose fitting 148. The cap member 138 is snapped into the interior of the collar 136 so that the barbed hose fitting protrudes outward from the open upper end 146 of the collar 136 and is freely rotatable therein about a central axis of the collar 136. The valve 140 is a one-way check valve, such as a duckbill valve, a cross slit valve, an umbrella valve, a mushroom valve or the like, that is disposed in the valve housing 150 of the cap member 138 and is configured to permit fluid flow in only one direction, outward from an interior of the cap member 138 through the barbed hose fitting. The receiver body 142 snaps into the cap member 138 to secure the valve 140 in place in the valve housing 150, and also includes a central coupler receiver 152 that is concentric or coaxially aligned with the valve 140 and connects the upper coupler body 128 of the thread reducer 20 to the valve 140 secured in the cap member 138, and forms a fluid tight seal therewith. The check valve 140 permits fluid received from the fluid flow coupler 124 to flow in one direction upward through the coupler receiver 152, through the check valve 140, and out the barbed fitting 148 connected to the fluid pump or fluid dispenser.

In various embodiments, the threaded insert 18 is configured such that the valve stem 28 disposed therein is in a closed position when no thread reducer 20 is attached thereto. For chemical manufacturers that ship bottled chemicals, such as cleaning fluids or the like, a container 14, such as a consumer sized bottle (e.g. a 1-gallon bottle), can be filled with the chemical at the manufacturing plant, and the manufacturer can affix a threaded insert 18 to the neck 12 thereof to secure the chemicals within the container 14. However, in alternate embodiments, to further secure the container, an externally threaded shipping cap (not shown), having a cover and externally threaded sidewalls can be threadedly mated to the insert housing 24 of the threaded insert 18 by screwing the threads of the shipping cap together with the second internal threads 54 in the open upper end of the insert housing 24. Such shipping cap would cover the valve stem 28 to prevent it from accidentally being depressed during shipping or otherwise, which could open the valve stem 28 and permit fluid in the container 14 to flow out therefrom when not desired. In yet an alternate embodiment, a removable or tear-off foil cover (not shown) can be affixed to the top surface 44 of the insert housing 24 of the threaded insert 18 to alternatively cover the valve stem 28 and prevent it from being depressed during shipping, or before the container 14 of fluid is ready to be used and fluid dispensed therefrom.

In still additional embodiments, the threaded insert 18 and thread reducer 20 can be provided or packaged together as a kit, in which the threaded insert is configured to be secured to the neck 12 of a container 14 containing fluids to be dispensed therefrom. The thread reducer 20 is configured to be secured to a legacy cap adapter 22 previously installed in a prior existing closed-loop dispensing system, and thereafter to the open upper end 38 of the insert housing 24 of the threaded insert 18.

In operation, a consumer can either purchase a container 14 of fluids, such as a chemical cleaner or the like, in which container 14 a threaded insert 18 has already been preinstalled therein that prevents spilling therefrom, or a consumer can purchase their own selected container 14 of fluids without a threaded insert 18, and which container 14 is instead sealed with a traditional screw-on closure cap or shipping cap.

In embodiments in which the container 14 has a threaded insert 18 pre-installed into the neck 12 of the container 14 at the factory, a user prepares the container 14 for use with a fluid pumping system or dispenser by first removing any additional ship cap installed in the open upper end 38 of the insert housing 24, or by removing any foil seal affixed to the ring shaped upper wall 42 of the insert housing 24.

In alternate embodiments in which a user purchases a container 14 of fluid that does not include a preinstalled threaded insert 18, such as an off-the-shelf 1-gallon bottle of concentrated cleaner or other chemicals from a big-box store or hardware store (i.e. a scenario in which the user may utilize a kit of the threaded insert and a thread reducer, as disclosed above), a user first removes any closure cap or ship cap, and/or any foil seal from the neck 12 thereof. The user then inserts the dip tube 34 of the of the threaded insert 18 into the neck 12 of the container 14 of fluid, and the remainder of the threaded insert 18 can then be inserted into the neck 12 of the container 14 and secured thereto by screwing the internal threads 50 of the first cylindrical sidewall 46, or collar, of the threaded insert 18 to the external threads 16 on the neck 12 of the container 14. Securing the threaded insert 18 by itself to the open neck of the container 14, without a thread reducer 20 coupled to the threaded insert 18, ensures the valve stem 28 in the threaded insert 18 remains biased to the closed position, and accordingly the container 14 to which the threaded insert 18 is connected remains substantially sealed closed until it is ready to be further connected to the dispensing system. In this manner, leaks from the container 14 through the threaded insert 18 are eliminated or minimized in the event that the container 14 is inadvertently knocked over at any time before it can be fully connected to the dispensing system.

Next, in one embodiment, to minimize the chance for accidental leaks or spills, the thread reducer 20 is first securely mated to the cap adapter 22, by screwing the internal threads 144 disposed on the collar 136 of the cap adapter 22 onto the second external threads 16 on upper reducer wall 114 of the thread reducer 20. The thread reducer 20 and cap adapter 22 are screwed together until a lower edge of the collar 136 is seated flush against an upper face of the flange 122 of the thread reducer. In doing so, as the thread reducer 20 is screwed into the cap adapter 22, the cylindrically shaped upper coupler body 128 of the thread reducer 20 becomes slidingly seated within the coaxially aligned coupler receiver 152 of the receiver body 142 in the cap adapter 22. The upper coupler body 128 and the coupler receiver 152 form a liquid tight seal at their respective cylindrical mating faces. In alternate embodiments (not shown), this connection between the cap adapter 22 and the thread reducer 18 can be achieved via a releasable quick release or snap structures instead of mating threaded structures, without departing from the scope of the present disclosure.

In one embodiment, the cap adapter 22 is reusable and is already previously installed to a dispensing system, wherein the barbed fitting 148 extending from the reusable cap adapter 22 is already connected to an end of a hose or tube of the dispensing system and the hose is also already affixed at an opposing end to a fluid pump or dispenser (not shown). In an alternate embodiment in which a new cap adapter must be installed, the hose or tube of the dispensing system is at that time affixed at one end (not shown) to the barbed fitting 148 extending from the cap adapter 22, and the opposing end of the hose is affixed to a fluid pump or dispenser (not shown). In some embodiments, the thread reducer 18 and cap adapter 22 can be permanently affixed to each other, such as by sonic welding the lower edge of the collar 136 of the cap adapter 22 to the upper face of the flange 122 of the thread reducer 20.

The thread reducer 20 (now already secured to the cap adapter 22) is then inserted into the open upper end 38 of the insert housing 24 of the thread reducer 18, and secured thereto by screwing the external threads 112 of the lower reducer wall 110 of the thread reducer 20 to the internal threads 54 of the second cylindrical sidewall 48 of the insert housing 24 of the threaded insert 18. The secured threaded mating of the thread reducer 20 to the threaded insert 18 causes the first socket 132 of the fluid flow coupler 124 to mate with and lower around an outer surface of the upper body portion 82 of the valve stem 28 such that the two slidingly engage each other and form a liquid tight seal at their mating surfaces. As the thread reducer 20 continues to screw into the insert housing 24, an upper edge of the valve stem 28 abuts against the shoulder 134 defined in the socket 132 of the lower coupler body 130. Further continued mating of the thread reducer 20 into the insert housing 24 causes the shoulder 134 to catch the top edge of the valve stem 28 and drive or force the valve stem 28 downward against the biasing force of the valve spring 30 from its closed position to its open position. This in turn causes the closed top end 100 of the valve body 98 and the lateral openings 102 defined therein to slidingly protrude upwards into, or enter, the larger diameter upper bore 84 of the upper body portion 82 of the valve stem 28. The lateral openings 102 in the fluid flow path are thereby uncovered and are open to fluid flow there through. With the valve stem 28 in its open position, all of the mated components along the complete fluid flow path are fluidically sealed to each other at their mating interfaces. In this state in which the valve stem is moved to the open position, the fluid pump or dispenser of the dispensing system can be activated to draw negative pressure suction in the hose affixed thereto. The negative pressure passes all the way from the pump or dispenser, through the container insert 10, and to the interior of the container 14 to which the container insert 10 is affixed. The negative pressure causes fluid in the container 14 to flow or be drawn upward from the dip tube 34 disposed at its lower end in the fluid stored in the container 14, and through each of the barbed dip tube fitting 96 and any metering tip 36 installed therein, the valve body 98, and the lateral openings 102 of the disc member 32, the upper body portion 82 of the valve stem 28, the coupler flow path 126 in the lower and upper coupler bodies 130, 128 of the thread reducer 20, a central pathway in the receiver body 142, the check valve 140, the valve housing 150 and the barbed fitting 148 of the cap member 138 in the cap adapter 22, and out to the pump (not shown) where it can be dispensed to a bucket or other desired receptacle for use.

1. A kit for use in dispensing a fluid from a container via a cap adapter of a negative pressure closed-loop dispensing system, the kit comprising:
a threaded insert including:
an insert housing having an internally threaded collar configured to be coupled to an externally threaded neck of the container, said insert housing defining an internally threaded open upper end,
a valve assembly disposed in said insert housing and having a valve stem that is moveable between an open position and a closed position, and
a dip tube in fluid communication with said valve assembly and configured to be introduced into a volume of fluid held within the container; and
a thread reducer, including:
a cylindrical externally threaded lower reducer wall configured to be coupled to said internally threaded open upper end of said insert housing of said threaded insert,
a cylindrical externally threaded upper reducer wall configured to be coupled to internal threads of the cap adapter,
a cylindrical fluid flow coupler configured to be coupled to an upper end of said valve stem and slidingly drive said valve stem from said closed position to said open position to permit fluid flow from said container through said valve assembly and fluid flow coupler, to said cap adapter, when said thread reducer is coupled to said insert housing of said threaded insert.

2. The kit of claim 1, wherein said insert housing comprises:
a ring-shaped upper wall having an outer radial edge and an inner radial edge, wherein said collar of said insert housing is a cylindrical outer first sidewall extending downward from said outer radial edge of said upper wall.

3. The kit of claim 2, wherein said internally threaded open upper end of said insert housing comprises:
an internally threaded cylindrical inner second sidewall disposed radially inward of said first sidewall and extending downward from said inner radial edge of said upper wall to define a female open upper end of said insert housing.

4. The kit of claim 3, wherein said insert housing further comprises:
a cylindrical third sidewall disposed below said second sidewall and defining an open lower end of said insert housing;
a horizontally disposed ring-shaped lower wall protruding inward from an inner surface of said third sidewall, and
a cylindrical hollow receiver extending upward from an inner edge of said lower wall.

5. The kit of claim 4, wherein said horizontally disposed ring-shaped lower wall includes a plurality of vent holes defined vertically therethrough.

6. The kit of claim 4, wherein said valve stem is disposed within said cylindrical hollow receiver.

7. The kit of claim 2, wherein said valve stem is disposed in said open upper end of said insert housing.

8. The kit of claim 2, wherein said valve assembly further comprises a spring that biases the valve stem to a closed position.

9. The kit of claim 1, wherein said lower reducer wall of said thread reducer has a smaller outer diameter than said upper reducer wall.

10. The kit of claim 1, wherein said thread reducer further comprises:
a horizontal ring-shaped wall disposed between, and separating, said lower reducer wall from said upper reducer wall.

11. The kit of claim 10, wherein said horizontal ring shaped wall of said thread reducer has at least one vertically arranged vent hole defined therethrough.

12. The kit of claim 10, wherein said cylindrical fluid flow coupler of said thread reducer comprises:
an upper coupler body disposed above said horizontal ring shaped wall and coaxially disposed within said upper reducer wall; and
a lower coupler body disposed below said horizontal ring shaped wall and coaxially disposed within said lower reducer wall and coaxially aligned with said upper coupler body, the coaxially aligned upper and lower bodies defining a coupler fluid flow path therethrough.

13. The kit of claim 12, wherein said lower coupler body of said thread reducer includes a first socket defined in a lower open end thereof that is configured to mate and form a fluid tight seal with an upper end of said valve stem when said thread reducer is mated to said threaded insert.

14. The kit of claim 13, wherein said first socket defines a shoulder configured to act as a physical stop against which a top surface of said valve stem is configured to abut when said thread reducer is mated to said threaded insert.

15. The kit of claim 12, wherein said upper coupler body is configured to mate and form a fluid tight seal with a coupler receiver of the cap adapter, when said thread reducer is coupled to the cap adapter.

16. The kit of claim 12, wherein said thread reducer further comprises:
a horizontal radial flange extending radially outward from an outer surface of one said upper or lower reducer walls, said radial flange having an upper face configured to act as a physical stop against which a lower edge face of the cap adapter will abut when said thread reducer is fully coupled to the cap adapter.
